(19) United States
(12) Patent Application Publication
(10) Pub. No.: US 2003/0078336 A1
(43) Pub. Date: Apr. 24, 2003

(54) Coating composition

(76) Inventors: Valeria Karchevsky, Bat-Yam (IL); Oleg Figovsky, Haifa (IL)

Correspondence Address: BLANK ROME COMISKY & MCCAULEY, LLP, 900 17TH STREET, N.W., SUITE 1000, WASHINGTON, DC, 20006, US

(21) Appl. No.: 09/983,026

(22) Filed: Oct. 22, 2001

(51) Int. Cl. C08K 3/20; C08K 3/00

(52) U.S. Cl. 524/501; 524/547

(57) ABSTRACT

Water-based cross-linkable composition for preparation of protective or adhesive coating applicable to various substrates is disclosed. The composition comprises aqueous dispersion of chlorosulfonated polyethylene (CSPE), epoxydimethylhydantoin resin and aqueous solution of tris-[dimethylaminoalkyl]-phenol. The composition is environmentally friendly and yields coatings with properties, which are not worse than properties of CSPE-based coatings manufactured with using of toxic organic solvents.

### BACKGROUND OF THE INVENTION

1. Field of the Invention

The present invention relates to protective coatings based on chlorosulfonated-polyethylene (CSPE), which are used for protecting of various substrates and in particular of those substrates, which are prone to cracking, e.g. concrete. It should be understood however that the invention is not limited to protection of concrete substrates and it can be employed for protecting substrates made of other materials.

2. Description of the Related Art

CSPE-based protective coatings are known in the art due to their excellent resistance to various aggressive environments, e.g. acids, oxidants, good mechanical properties etc. These coatings are described for example in Paint Handbook, Mc.Graw-Hill,Inc., U.S.A. 1988, pp.12-8, 17-6 or in the book Surface Coatings, v.2, Paints and their applications, Australia, p.497. CSPE is a saturated elastomer defined by exceptional chemical resistance imparting to the coating made of it good resistance against ozone, UV, weather corrosion, oil, gasoline and fire as well freeze and heat resistance and wear resistance. The CSPE coatings are usually applied on concrete, ceramic, metal, plastics and other substrates for protecting of roofs, walls, tanks etc. Examples of commercially available coatings, based on CSPE are so-called Hypalon coatings GacoFlex H-25 and GacoFlex H-22 produced by Gaco Western Inc. The Hypalon coatings yield an elastomeric film of good wear, weather and resistance and durability that will resist most chemical environments. The coatings are recommended for use in roofing over concrete, single-ply, plywood as weathering topcoat, for repairing tears, holes and seam separations. The coatings could be laid over various primers and elastomeric base coats including neoprene and polyurethane. The disadvantage of the known in the art CSPE coatings is associated with the fact that so far they are prepared from aromatic solutions only and thus organic solvents are required for during their manufacturing, e.g. xylene, toluene, carbon tetrachloride, chloroform etc. Since these solvents are flammable and poisoning compounds and since relatively large amounts of such compounds should be used during manufacturing of CSPE-based coatings (concentration of CSPE in the coating composition is not more than 20%) the manufacturing process itself and so the CSPE coatings produced thereby are not safe and hazardous for the environment. It would be very desirable to replace organic solvents by water and thus to develop ecologically clean CSPE-based coatings, retaining good mechanical properties and above listed resistance to various aggressive environments. Unfortunately properties of aqueous CSPE dispersions are insufficient for their practical use and at the same time it is not possible to carry out vulcanization of CSPE in water since known in the art cross-linking agents (see for example U.S. Pat. No. 5,912,288, U.S. Pat. No. 5,976,402, U.S. Pat. No. 5,952,425), which would be suitable for cross-linking of CSPE are insoluble in water.

### SUMMARY OF THE INVENTION

The main object of the present invention is directed to developing of water soluble composition suitable for preparation of CSPE coatings, which are environmentally friendly and at the same time their various mechanical properties and resistance to aggressive environments is at least not worse, than similar properties of the known in the art CSPE coatings based on organic solvents.

Still further object of the invention is to provide simple and inexpensive composition for preparation of CSPE coatings from water dispersion of CSPE. Yet another object of the invention is to provide new composition for CSPE water-soluble coatings, which could be easy and conveniently applied to various substrates.

It has been empirically revealed, that it is possible to induce cross-linking in water dispersion of CSPE by addition of tris-[dimethylaminoalkyl]-phenol or so-called Mannich base in the presence of epoxydimethylhydantoin resin.

It has been established, that when all three components are combined the cross-linking reaction initiates and results in a CSPE-based coating having very good mechanical properties and chemical resistance.

Despite the fact that Mannich bases are well known compounds their use as cross-linking agents so far has been associated merely with epoxy resin systems (see e.g. U.S. Pat. No. 5,569,536, U.S. Pat. No. 5,576,108). At the same time Mannich bases are used as stabilizers for CSPE (see U.S. Pat. No. 5,672,574). Therefore it has been rather surprising to discover that it is possible to cross link an aqueous suspension of CSPE by Mannich base in presence of a third compound, which is epoxydimethylhydantoin resin.

One possible explanation of this unexpected result is creation of strong spatial polymeric structures on the account of reaction centers, which include chlorine-sulfonate groups, epoxy groups and radicals of Mannich group. Due to active interaction between these groups strong adhesion bonds are created between the system components and between coating and substrate. The created bonds are defined by high energetic level and become even stronger due to distinct polarity of the elastomeric coating.

### BRIEF DESCRIPTION OF THE DRAWINGS

FIGS. 1a-d and 2 are structural formulae of various compounds suitable for use in the present invention

FIG. 3 shows table with examples of compositions of the invention

FIG. 4 summarizes properties of the compositions shown in FIG. 3

FIG. 5 shows table with compositions of the invention and of some commercially available coatings

FIG. 6 shows table, comparing properties of compositions shown in FIG. 5

### DETAILED DESCRIPTION OF THE PREFERRED EMBODIMENTS

The present invention deals mainly with a cross-linkable composition for manufacturing of CSPE-based coatings for protecting of various substrates.

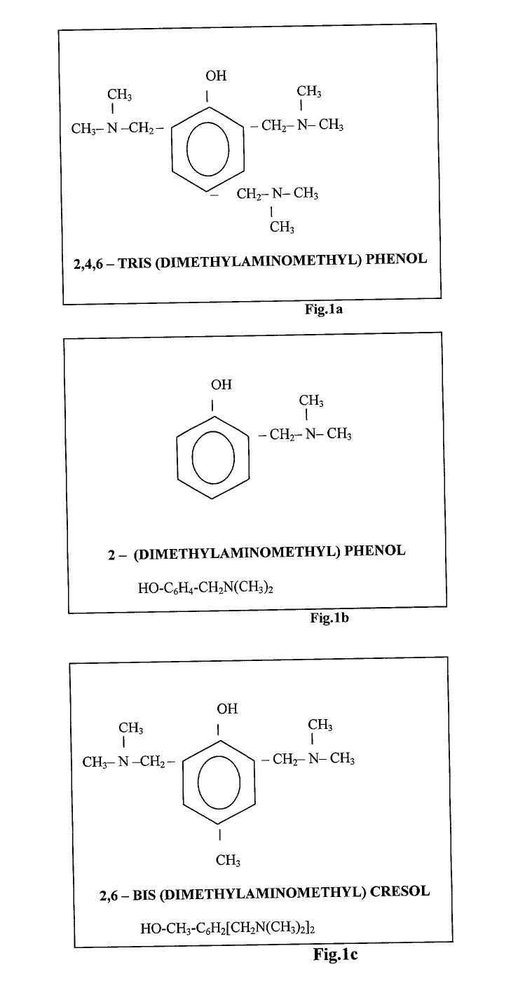

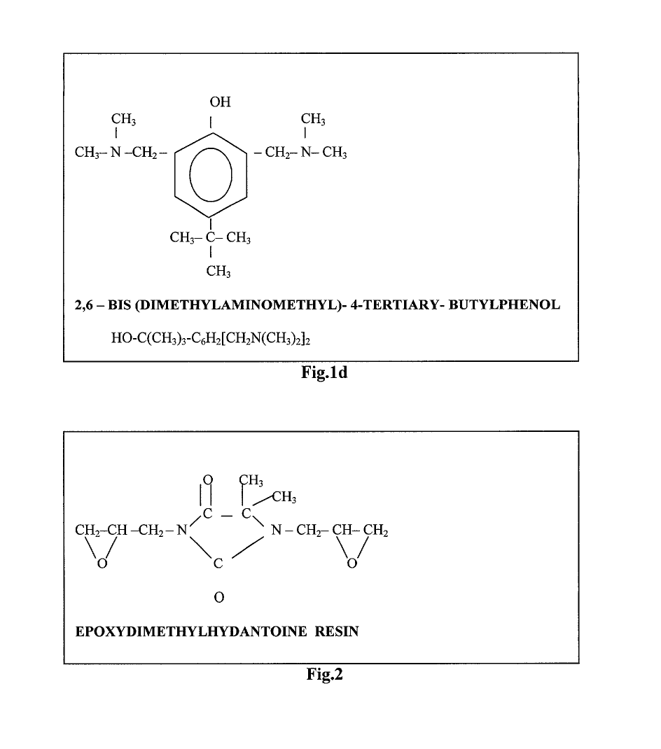

In accordance with the invention the composition comprises an aqueous dispersion of CSPE, a water-soluble Mannich base and an epoxydimethylhydantoin resin, which chemical and structural formulae are shown in FIGS. 1, 2.

If necessary the composition includes also a filler component and a color component (pigment).

In practice concentration of polymer in the dispersion should be 37-50 weight percent, being preferably 38.5-48.5 weight percent.

The epoxydimethylhydantoin resin should be an oligomer with molecular mass between 240 and 280 and with amount of epoxygroups between 29 and 33 percent.

As suitable Mannich base one can use water-soluble compounds selected from the group, consisting of 2,4,6-tris(dimethylaminomethyl) phenol, 2-(dimethyl aminomethyl) phenol, 2,6-bis(dimethylaminomethyl) cresol, 2,6-bis(dimethylaminomethyl)-4-tertiarybutylphenol, being preferably 2,4,6-tris(dimethylaminomethyl) phenol. The structural formulae of these compounds are shown in FIGS. 1a-d.

As suitable filler component one can use inorganic compounds, i.e. salts, oxides, hydroxides etc. Some examples of such filler components are BaSO₄, ZnO, Mg(OH)₂. In practice it is advantageous if the amount of filler component in the composition is 35-45 weight percent and if it is selected from the group, comprising MgO, ZnO and Mg(OH)₂, since these compounds are capable to function as additional cross-linking agents.

As suitable color component one can use mineral pigments, e.g. oxides, like TiO₂, Cr₂O₃, Fe₂O₃ etc.

The composition of the invention is prepared as follows. Water dispersions of two main components, i.e. CSPE and epoxydimethylhydantoin resin are thoroughly mixed in a ball mill for 30-35 minutes at room temperature and normal pressure. The third main component, i.e. water solution of Mannich base is added to the mixture immediate before applying the coating. It is advantageous to use separate receptacle for mixing all three components and in practice appropriate manual mixing device could be used in which the two already mixed components are mixed with the Mannich base component. After all three components have been mixed for 5-10 minutes the composition is ready for use as a coating. The coating can be applied on a substrate by any suitable known in the art method, e.g. by brushing, by spraying etc. Several layers of the coating could be applied and each layer should be dried for 6-8 hours at ambient temperature, which is not lower than 15 degrees C.

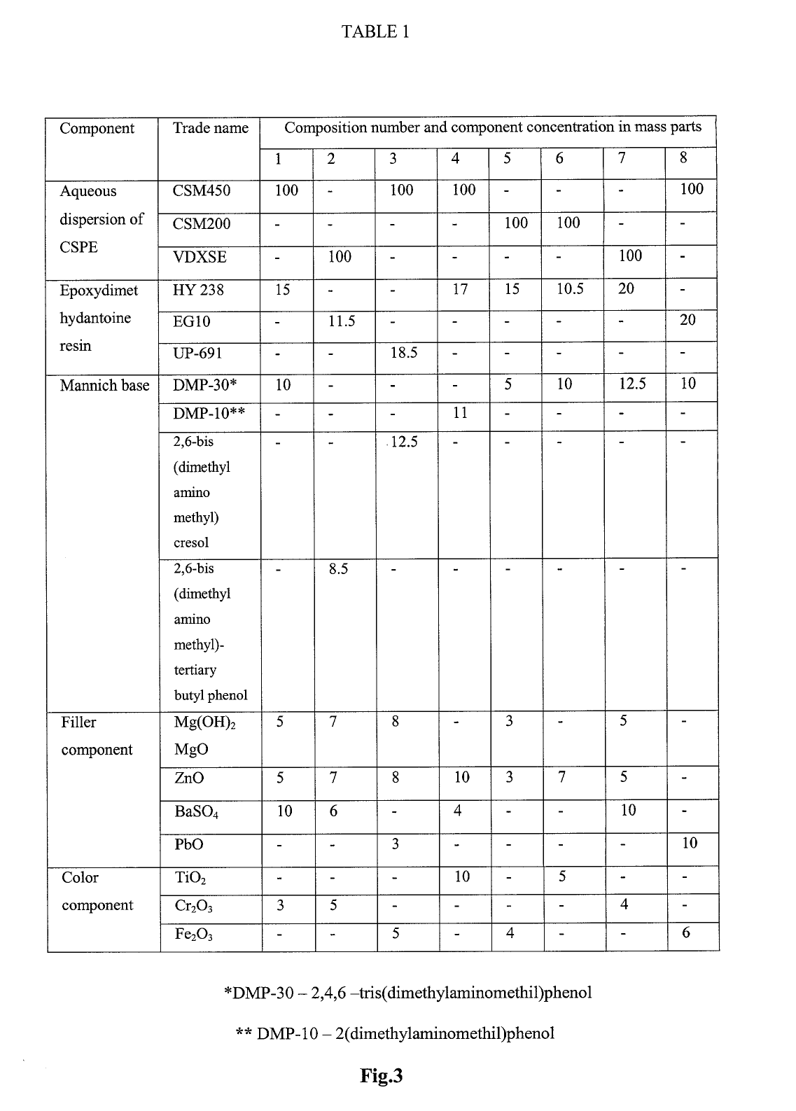

In non-limiting Table 1, presented in FIG. 3 some compositions of the invention are summarized.

The following main components were used in the compositions, summarized in the table:

1) Aqueous dispersion of CSPE

a) 40% aqueous dispersion of CSPE, namely products CSM-450™ and CSM-200™, manufactured by Sumitomo Seika Chemical Ltd., Japan.

b) 48% aqueous dispersion of CSPE, namely product VD-XSPE, manufactured by NIIMSI, Jaroslavl, Russia

2) Epoxydimethylhydantoin resin

a) Araldite HY238™, manufactured by Ciba Geigy AG, Switzerland

b) EG-10, manufactured by pilot plant GIPI LPK, Moscow, Russia

c) UP-691, manufactured by pilot plant UkrNIPM, Donezk, Ukraine

3) Mannich base

a) DMP-30™,DMP-10™ manufactured by Room & Haas Co., U.S.A.

b) K-54, manufactured by Anchor Chemicals Ltd., England

c) DY-064 Ciba Geigy AG, Switzerland

d) UP-606, manufactured by plant RIAP, Ukraine

Besides of the above main components some of the compositions included also filler component and a pigment.

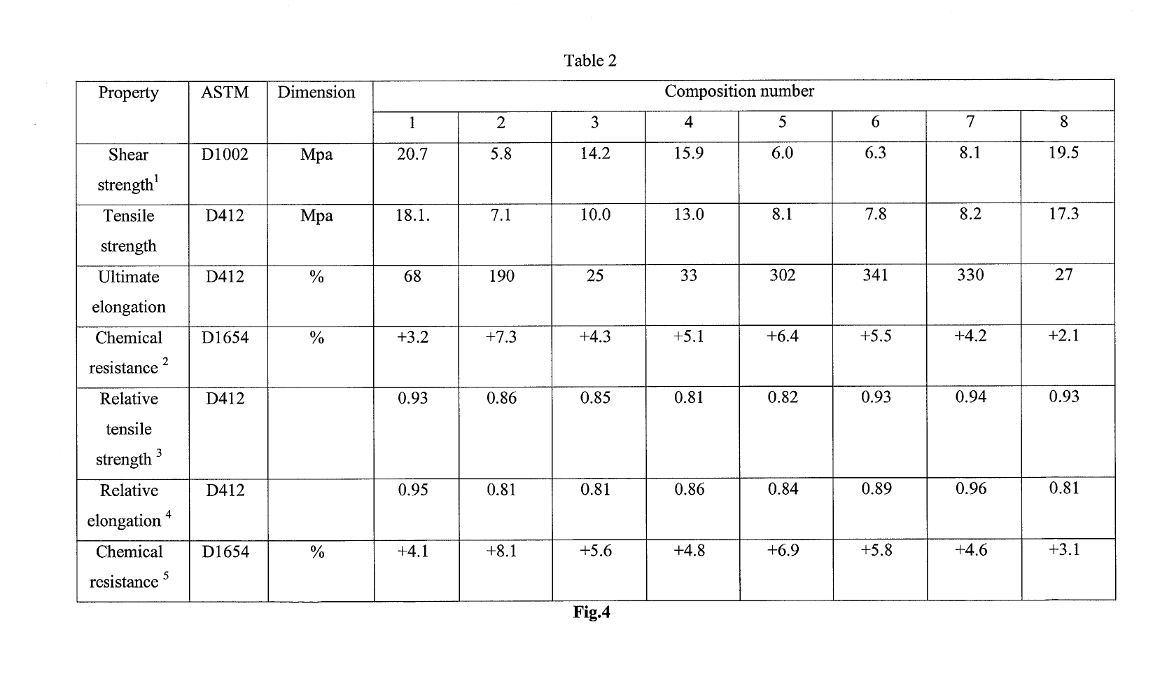

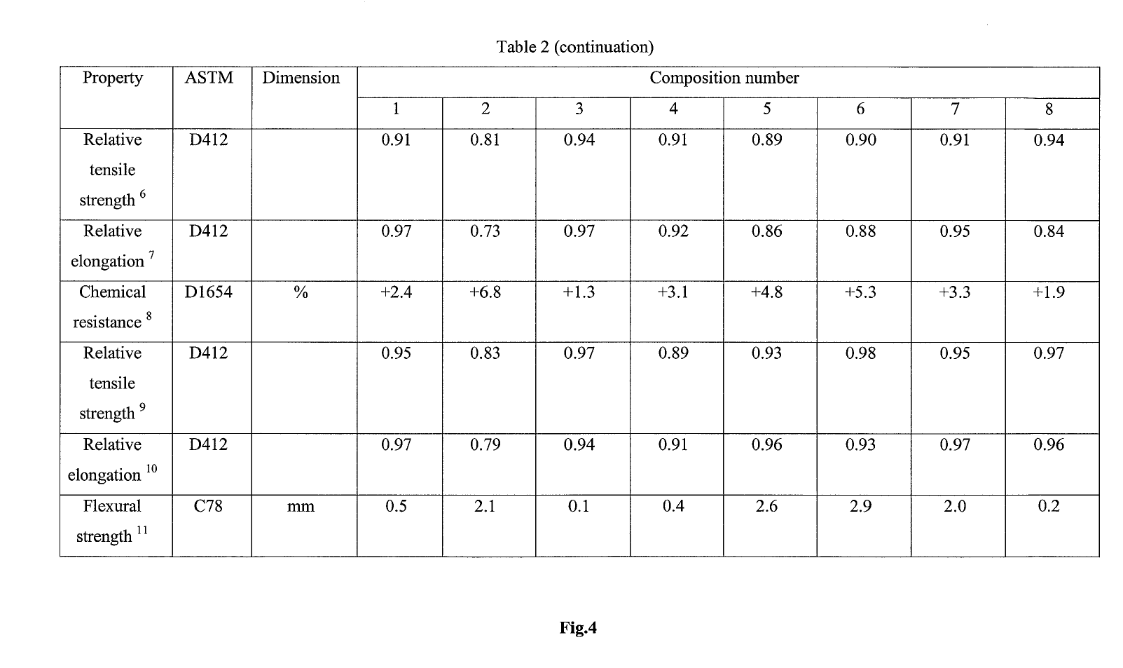

The summarized in Table 1 composition were used for preparation of free films and their various properties were tested. Most of the properties were measured on free films not adhered to any particular substrate. Only adhesion strength was measured on films, applied as a coating to metallic substrate. The measured properties are summarized in non-limiting Table 2, shown in FIG. 4. The meaning of small numerals in the property column is as follows:

1—refers to adhesion strength of a coating applied to metallic substrate; measured as apparent shear strength to tension loading

2—refers to chemical resistance to exposure to 60% H₂SO₄ for 250 hours; measured as film weight change

3—refers to corrosion resistance to exposure to 60% H₂SO₄ for 250 hours; measured as ratio between tensile strength of film after exposure and before exposure

4—refers to corrosion resistance to exposure to 60% H₂SO₄ for 250 hours; measured as ratio between ultimate elongation of film after exposure and before exposure

5—refers to chemical resistance to exposure to 20% H₂SO₄ for 250 hours; measured as film weight change

6—refers to corrosion resistance to exposure to 20% H₂SO₄ for 250 hours; measured as ratio between tensile strength of film after exposure and before exposure

7—refers to corrosion resistance to exposure to 20% H₂SO₄ for 250 hours; measured as ratio between ultimate elongation of film after exposure and before exposure

8—refers to chemical resistance to exposure to 40% NH₄OH for 250 hours; measured as film weight change

9—refers to corrosion resistance to exposure to 40% NH₄OH for 250 hours; measured as ratio between tensile strength of film after exposure and before exposure

10—refers to corrosion resistance to exposure to 40% NH₄OH for 250 hours; measured as ratio between ultimate elongation of film after exposure and before exposure

11—refers to flexural strength of film; measured as width of crack obtained in flexural test of concrete beam and still covered by the film.

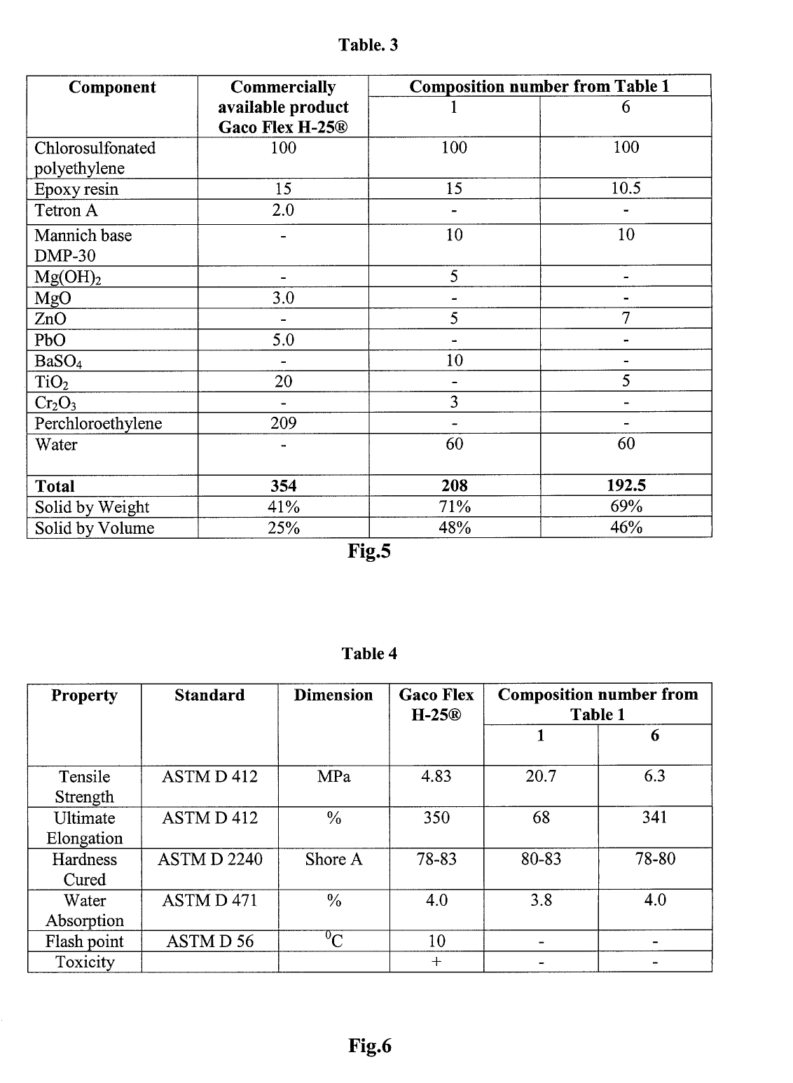

In Tables 3,4, which are shown in corresponding FIGS. 5,6 properties of some of the compositions of the invention are compared with similar properties of the known in the art compositions, which are based on CSPE and manufactured with using of organic solvents. On the basis of results summarized in table 4 one can conclude that compositions of the present invention, employing aqueous dispersions and solutions ensure obtaining of coatings with properties, which are at least not worse than the properties of coatings manufactured by conventional methods, employing organic solvents. It could be easily appreciated that since compositions of the invention employ only water-based components they are environmentally friendly. Furthermore the compositions of the invention are inexpensive and very simple in preparation, since all required components are commercially available and ready for use compounds.

By virtue of the above properties the compositions of the invention are suitable for applications in various industries either as corrosion resistant, water resistant, weather resistance, abrasion resistant, impact resistance and crack resistant protective coatings or as adhesion material. Among possible industries one can mention aviation industry, automobile industry, shipbuilding industry, paint industry, etc. In these industries the invention can be implemented e.g. for:

Applying protective flexible waterproof coatings on concrete roofs, various monolithic and assembled concrete constructions, etc.

Applying protective anticorrosive coatings on metallic and concrete receptacles, vessels, piping etc.

Applying protective anticorrosive coatings on various constructions deployed in seawater

Applying protective anticorrosive coatings on buildings and constructions located near to sea

Impregnating of various fabrics

Adhesion of various materials.

The present invention is not limited by the above-described embodiments and one ordinarily skilled in the art can make changes and modifications without deviation from the scope of the invention as will be defined below in the appended claims.

It should also be appreciated that features disclosed in the foregoing description, and/or in the foregoing drawings, and/or examples, and/or tables, and/or following claims both separately and in any combination thereof, be material for realizing the present invention in diverse forms thereof.

What is claimed:

1. A cross-linkable composition, essentially for use as protective or adhesive coating, said composition comprising the following main components, by weight:

| | |
|---|---|
| a) Chlorosulfonated polyethylene (CSPE) | 100 |
| b) Epoxydimethylhydantoin resin | 10.0-20.0 |
| c) tris-[dimethylaminoalkyl]-phenol | 5.0-15.0 |

2. A cross-linkable composition as defined in claim 1, which comprises aqueous dispersion of chlorosulfonated polyethylene, said aqueous dispersion has a mass concentration of 37-50%.

3. A cross-linkable composition as defined in claim 2, in which said epoxydimethylhydantoin resin has molecular mass 240-280 and mass concentration of epoxy groups 29-32%.

4. A cross-linkable composition as defined in claim 1, in which said tris-[dimethylaminoalkyl]-phenol comprises water-soluble Mannich base, selected from the group consisting of 2,4,6-tris(dimethylaminomethyl) phenol, 2-(dimethylaminomethyl) phenol, 2,6-bis(dimethylaminomethyl) cresol, 2,6-bis(dimethylaminomethyl)-4-tertiary-butylphenol.

5. A cross-linkable composition as defined in claim 1, comprising the following additives, in mass percents

| | |
|---|---|
| a filler | 3-10 |
| a pigment | 3-10. |

6. A cross-linkable composition as defined in claim 5, in which said additives are inorganic compounds, selected from the group consisting of oxides, hydroxides and salts.

7. A coating for protecting or adhesion of various substrates, said coating comprises by weight:

| | |
|---|---|
| a) Chlorosulfonated polyethylene (CSPE) | 100 |
| b) Epoxydimethylhydantoin resin | 10.0-20.0 |
| c) tris-[dimethylaminoalkyl]-phenol | 5.0-15.0 |

8. A coating as defined in claim 7, in which said epoxydimethylhydantoin resin has molecular mass 240-280 and mass concentration of epoxy groups 29-32 and said tris-[dimethylaminoalkyl]-phenol comprises water-soluble Mannich base, selected from the group consisting of 2,4,6-tris(dimethylaminomethyl) phenol, 2-(dimethylaminomethyl) phenol, 2,6-bis(dimethylaminomethyl) cresol, 2,6-bis(dimethylaminomethyl)-4-tertiary-butylphenol.

9. A coating as defined in claim 8, comprising the following additives, in mass percents

| | |
|---|---|
| a filler | 3-10 |
| a pigment | 3-10 |

10. A coating as defined in claim 5, in which said additives are inorganic compounds, selected from the group consisting of oxides, hydroxides and salts.

11. A method for using a coating composition comprises the following steps:
a) providing a water-based mixture of chlorosulfonated polyethylene (CSPE) with epoxydimethylhydantoin resin;
b) providing an aqueous solution of tris-[dimethylaminoalkyl]-phenol;
c) mixing said separate components and cross-linking the CSPE to form said coating.

12. The method as defined in claim 11, wherein said water-based mixture comprises an aqueous dispersion of CSPE with a mass concentration of 37-50%.

13. The method as defined in claim 12, wherein said epoxydimethylhydantoin resin has molecular mass 240-280 and mass concentration of epoxy groups 29-32%.

14. The method as defined in claim 11, wherein said aqueous solution of tris-[dimethylaminoalkyl]-phenol comprises water-soluble Mannich base, selected from the group consisting of 2,4,6-tris(dimethylaminomethyl) phenol, 2-(dimethylaminomethyl) phenol, 2,6-bis(dimethylaminomethyl) cresol, 2,6-bis(dimethylaminomethyl)-4-tertiarybutylphenol.

15. The method of claim 11, wherein said water based mixture comprises an aqueous dispersion of CSPE with a mass concentration of 38.5-48.5%.

16. The method according to claim 11 utilizing the composition of claim 1.

17. The method according to claim 11 utilizing the composition of claim 9.

18. The method according to claim 11 utilizing the composition of claim 10.
